(19) United States
(12) Patent Application Publication
(10) Pub. No.: US 2025/0206384 A1
(43) Pub. Date: Jun. 26, 2025

(54) INSTRUMENT PANEL CROSSMEMBER

(71) Applicant: GF Casting Solutions AG, Schaffhausen (CH)

(72) Inventors: Stephan PHILIPP, Gailingen (DE); Marc GUNIA, Schaffhausen (CH); Benedikt STARK, Stühlingen (DE); Steven TSCHEPE, Aach (DE)

(21) Appl. No.: 18/986,909

(22) Filed: Dec. 19, 2024

(30) Foreign Application Priority Data
Dec. 21, 2023 (EP) 23218946.4

(51) Int. Cl. B62D 25/14; B62D 29/00

(52) U.S. Cl. CPC B62D 25/145; B62D 29/008

(57) ABSTRACT

An instrument panel crossmember of a motor vehicle including a crossbeam. The crossbeam extends transversely to a longitudinal direction of the motor vehicle from an A pillar to an opposite A pillar. The crossbeam is adjoined in a direction of the vehicle front by a plate. At least one instrument opening configured for reception of an instrument is formed in the plate.

### CROSS REFERENCE TO RELATED APPLICATIONS

This application claims benefit to European Patent Application No. EP 23218946.4, filed on Dec. 21, 2023, which is hereby incorporated by reference herein.

### FIELD

The present disclosure relates to an instrument panel crossmember and its production method.

### BACKGROUND

In modern motor vehicles, a crossmember that extends substantially exclusively horizontally from one A pillar to the opposite A pillar is generally provided as a load-bearing component for the purpose of fastening various cockpit functions. Additional separately formed components with different functions, e.g. a fastening for an imaging unit of a heads-up display or other instrument fastening elements, as well as other components, are fastened to the crossmember.

DE 10 2022 116 803 B3 discloses an instrument panel that has a supporting frame on which a multiplicity of additional functional components, e.g. an electrically operable display element, are fastened by means of additional separately formed carrier parts. This has the disadvantage of a high assembly effort. In addition, by virtue of its configuration, the supporting frame does not support any significant force dissipation/force absorption in the event of a crash.

DE 10 2013 212 878 A1 discloses a structural cockpit component which includes a cockpit crossmember, on which a separately formed heads-up display housing with supports is arranged, and a separate body shell crossmember. Here too, there is the disadvantage of the large number of individual parts that must be assembled.

The crossmembers known from the prior art extend exclusively between the two A pillars, and additional supporting elements are fitted to the crossmember to receive additional functional components. Moreover, the crossmembers from the prior art are not suitable, owing to their structural shape, for absorbing forces in the event of a crash or dissipating them to attached components, and they fail due to buckling or breaking.

### SUMMARY

In an embodiment, the present disclosure provides an instrument panel crossmember of a motor vehicle comprising a crossbeam. The crossbeam extends transversely to a longitudinal direction of the motor vehicle from an A pillar to an opposite A pillar. The crossbeam is adjoined in a direction of the vehicle front by a plate. At least one instrument opening configured for reception of an instrument is formed in the plate.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a three-dimensional view of an embodiment of an upper side of an instrument panel crossmember directed onto a support obliquely from the front;

FIG. 2 shows a three-dimensional view of an embodiment of the upper side of the instrument panel crossmember directed onto the crossbeam obliquely from the rear;

FIG. 3 shows a three-dimensional view of an embodiment of an underside of the instrument panel crossmember directed onto the support obliquely from the front;

FIG. 4 shows a three-dimensional view of the embodiment of the underside of the instrument panel crossmember directed onto the support obliquely from the front;

FIG. 5 shows a three-dimensional view of an embodiment of the underside of the instrument panel crossmember directed onto the support obliquely from the front; and

FIG. 6 shows a three-dimensional view of an embodiment of the instrument panel crossmember installed in a schematic vehicle body.

### DETAILED DESCRIPTION

In an embodiment, the present invention provides an instrument panel crossmember and an associated method for the production thereof by means of which the accommodation of functional elements is integrated, and the instrument panel crossmember performs the function of force dissipation/force absorption in the event of a front impact.

According to an embodiment, this is achieved by the crossbeam being adjoined in the direction of the vehicle front by a plate, wherein at least one instrument opening for the reception of an instrument is formed in the plate.

The instrument panel crossmember according to an embodiment for a motor vehicle comprises a crossbeam, wherein the crossbeam extends transversely to the longitudinal direction of the motor vehicle from an A pillar to an opposite A pillar. The longitudinal direction of the vehicle extends in the X direction, the Y direction extends transversely or at right angles horizontally to the vehicle longitudinal direction, and the Z direction extends perpendicularly to the vehicle longitudinal direction or, alternatively, to the Y direction, i.e. upwards or downwards. A plate adjoins the crossbeam or is arranged on the crossbeam in the direction of the vehicle front or in the X direction. At least one instrument opening for the reception of an instrument is formed in the plate, wherein an instrument is interpreted to mean an imaging unit of a heads-up display and other display means, such as on-board computers, navigation systems etc.

It is advantageous if the instrument panel crossmember is designed as a thin-walled component and has a wall thickness in the range of from 1 to 4 mm, preferably a wall thickness of from 1.5 to 3 mm. The wall thickness can vary over the extent of the instrument panel crossmember, that is to say that the wall thickness can be designed to be thicker, e.g. 3.5 mm, in some regions of the instrument panel crossmember, e.g. the crossbeam, and thinner, e.g. 1.5 mm, in some regions.

It is advantageous if the plate is arranged integrally on the crossbeam. That is to say that the instrument panel crossmember is of one-piece design, or the crossbeam and the plate are integral or form a single whole and are produced as a single casting without the need to join the plate and the crossbeam together.

The instrument panel crossmember is preferably produced from a metallic material. In combination with the configuration of the instrument panel crossmember, this enables the instrument panel crossmember to comply with the crash requirements and to dissipate and/or absorb the occurring forces without failing. In this case, the instrument panel crossmember is preferably produced from a material. The instrument panel crossmember is preferably produced from light alloy.

The plate preferably runs horizontally, or the plate extends in the X-Y direction.

In an embodiment, the instrument panel crossmember is designed as a thin-walled, one-piece component. The wall thickness can vary over the cross section of the instrument panel crossmember.

It is advantageous if at least one instrument opening is arranged in the plate for the reception of an imaging unit. It is thereby possible to avoid the mounting of additional carrier elements, thereby increasing the economy of manufacture of the instrument panel crossmember.

It has proven advantageous if at least two instrument openings are arranged in the plate for the reception of imaging units. It is a distinguishing feature in the development of the vehicles not only that relatively small items of information such as the permitted speed are projected onto the windscreens or a display screen but that the entire windscreen is used to incorporate driver-relevant information and even the entire vehicle environment in the form of augmented reality into the projection on the windscreen, and it is therefore quite possible to arrange more than just one imaging unit on an instrument panel crossmember in order to fully cover the projection area.

In an embodiment, the instrument opening has a cooling surface, against which the imaging unit rests in surface contact and which carries away the heat from the imaging unit. The cooling surface is preferably arranged integrally in the plate and runs obliquely to the plate. In addition, the large continuous surface of the instrument panel crossmember is used for heat dissipation, whereby the instrument panel crossmember, as a unit per se, acts as a heat sink. As a result, it is possible to dispense with additional (active) cooling measures for the imaging units, the said measures taking up installation space.

The instrument opening preferably has a cooling surface, on which cooling fins are arranged on the side facing away from the imaging unit, or on the rear side or underside. Air, preferably air cooled by an HVAC unit, is passed through the cooling fins in order to carry the heat away from the imaging unit.

It has proven advantageous if fastening openings, which are used to fasten the instruments and the HVAC unit, are arranged in the plate. By means of these fastening openings and preferably a fastening element, such as a clamping element, the instruments and assemblies to be mounted are fastened to the plate.

The plate is preferably surrounded by a support in the direction of the vehicle front, at least in some region or regions. It has proven advantageous if the plate is of circular-segment-shaped design in the direction of the vehicle front. This circular-segment shape is preferably surrounded or framed, at least in some region or regions, by a support that runs in an arc shape.

It is advantageous if the support running in an arc shape has a U-shaped cross section. The U shape is preferably open downwards or in the negative Z direction. The U shape is preferably used for the routing of an air duct and can be connected to an HVAC unit, which is preferably fastened to the underside of the instrument panel crossmember. The U shape can be used as part of an air duct, to which a corresponding air duct cover that runs along the U shape and thereby forms a closed air duct is fastened. The air duct can also be formed as a moulded plastic duct that is inserted into the U shape and has corresponding outlets for supplying air to the windscreen. It is thereby optionally possible to integrate the windscreen ventilation system directly into the support by, for example, also providing ventilation slots in the support, which guide the air from an HVAC unit through the U-shaped support to the windscreen. Of course, the U shape or U-shaped cross section of the support can also be used as a cable duct or else for both. It is advantageous if the HVAC unit is arranged on the underside of the instrument panel crossmember or the plate and is connected to an air duct running along the underside or in the U shape of the support and/or of the crossbeam. It has furthermore proven advantageous that, in the event of a crash, optimum introduction of force into the body is ensured and force absorption generally improved by the U shape of the support and by the integral attachment of the support to the crossbeam or the end portions thereof.

In an embodiment, the crossbeam has a U-shaped cross section, at least in some portion or portions. The crossbeam arranged integrally on the instrument panel crossmember preferably has a U shape in the central portion and has end portions adjoining on both sides. At least one portion of the crossmember preferably extends as a U profile. The end portions preferably have a closed cross section. It has proven advantageous if the plate integrally adjoins one leg of the U-shaped cross section of the crossbeam and extends in the vehicle front. It has furthermore proven advantageous if the plate integrally adjoins one leg of the support of the U-shaped cross section. The plate is preferably integrally surrounded by the crossbeam and the support, at least in some region or regions.

The U shape or the U-shaped cross section of the crossbeam is preferably open downwards or in the Z direction. This allows ordered and well-positioned routing of the cables, for example, and/or it can also be used as a guide duct for feed and discharge lines for an HVAC unit on the underside of the instrument panel crossmember or on the underside of the crossbeam. Moreover, the U-shaped cross section of the crossbeam provides high rigidity.

It has proven advantageous if the instrument panel crossmember is designed as a light-alloy diecasting, which serves to save weight.

When reference is made to an integrally arranged element on the instrument panel crossmember according to the present disclosure, this is always formed in one piece with the instrument panel crossmember according to the present disclosure or should be interpreted as belonging to it as to a single whole and that the instrument panel crossmember according to the present disclosure is produced as a single piece and includes the said elements and that no separate structure-imparting or load-bearing parts are provided by any joining processes whatsoever.

It is advantageous if a duct extends at least partially between the vertex of the arc-shaped support and the crossbeam in the vehicle longitudinal direction. The duct preferably extends along the X direction and preferably runs in the centre of the instrument panel crossmember. It is advantageous if the duct adjoins the U shape of the support. It is thereby possible to route the air along the support into the centre of the instrument panel crossmember, where an HVAC unit is preferably arranged. As already mentioned, this routing of the air takes place on the underside of the instrument panel crossmember. The duct furthermore entails the advantage of further stiffening of the instrument panel crossmember, as a result of which the instrument panel crossmember has less tendency to buckle in the event of a front impact.

The duct preferably extends in the plate. It has proven advantageous if the duct is formed integrally in the plate. Moreover, it is also advantageous if the duct extends only over a certain region of the plate.

It has proven to be an advantageous embodiment if an integral steering column duct extends in the vehicle longitudinal direction from the crossbeam to the support. It is advantageous if the steering column duct is arranged between the end portion and the U-shaped part of the crossbeam and extends in the X direction. It has proven advantageous if the steering column duct is designed as a U shape that is open downwards or in the negative Z direction.

It is advantageous if the steering column duct is of U-shaped design. Apart from the fact that such a steering column duct serves for the passage of the steering column in the motor vehicle, it also serves to stiffen the instrument panel crossmember. It has also proven advantageous if ribs are additionally arranged in the U shape.

The U shape of the steering column duct is preferably open downwards or in the Z direction. As already mentioned, the advantageous embodiment is due inter alia to the construction of a motor vehicle since the steering column must pass through.

In the end portions, the crossbeam preferably has a tubular portion with a closed cross section. It is advantageous if the tubular portion is open continuously in the Y direction and merges into the U-shaped portion of the crossbeam. This makes it possible, for example, to draw cables from one A pillar to the other A pillar. It has proven advantageous if the end portions have a closed cross section or are of tubular design and are closed in the Y direction towards the central portion of the crossbeam, which portion has a U shape, and thus no continuous duct is formed from one A pillar to the other A pillar. Instead of a continuous duct, a boundary element is arranged at the end of the closed cross section or tubular portion of the end portion in the region of the transition to the U-shaped cross section. The end portions preferably have, at each of the outer ends thereof, an A-pillar connection to enable them to be connected to the A pillars.

According to an embodiment, the instrument panel crossmember is produced by diecasting. The production of the instrument panel crossmember enables various instruments to be accommodated in one component without having to mount additional carriers on the crossbeam. Moreover, it can be of thin-walled design while nevertheless meeting the requirements for stiffness and the crash requirements.

All the embodiment possibilities can be freely combined with one another, and the features of the device can also automatically relate to the method and vice versa to avoid repetitions.

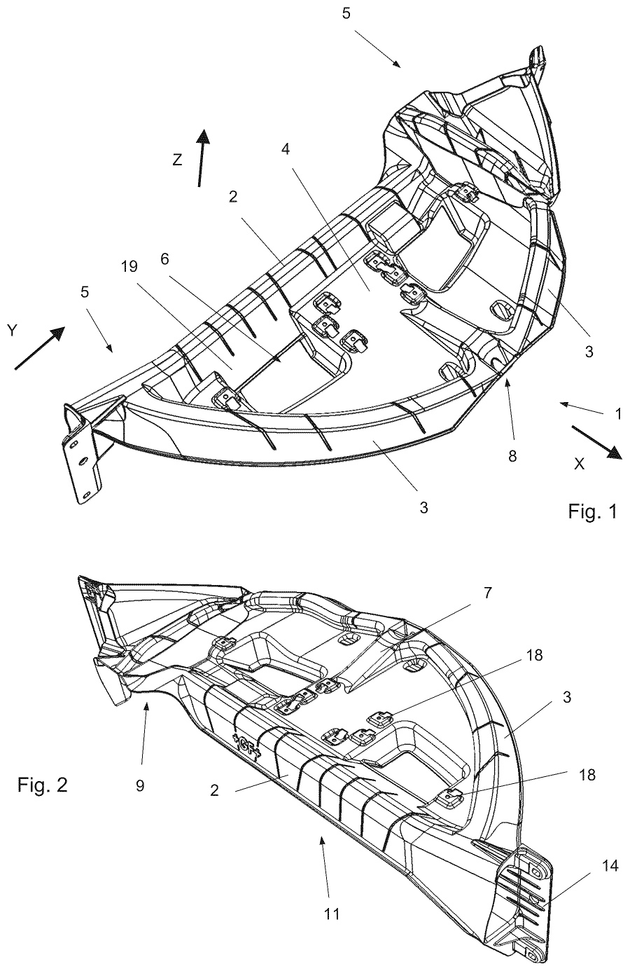

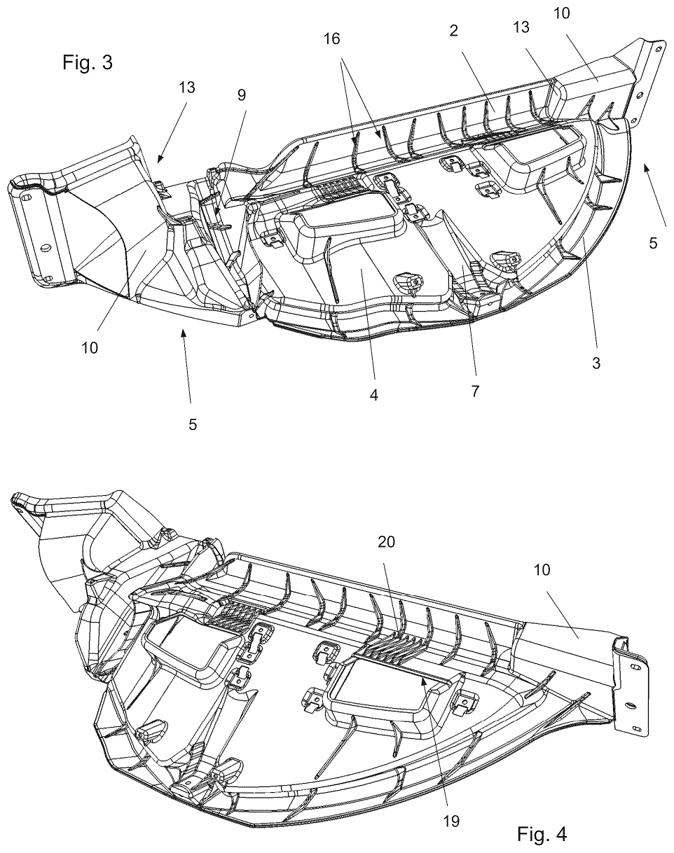

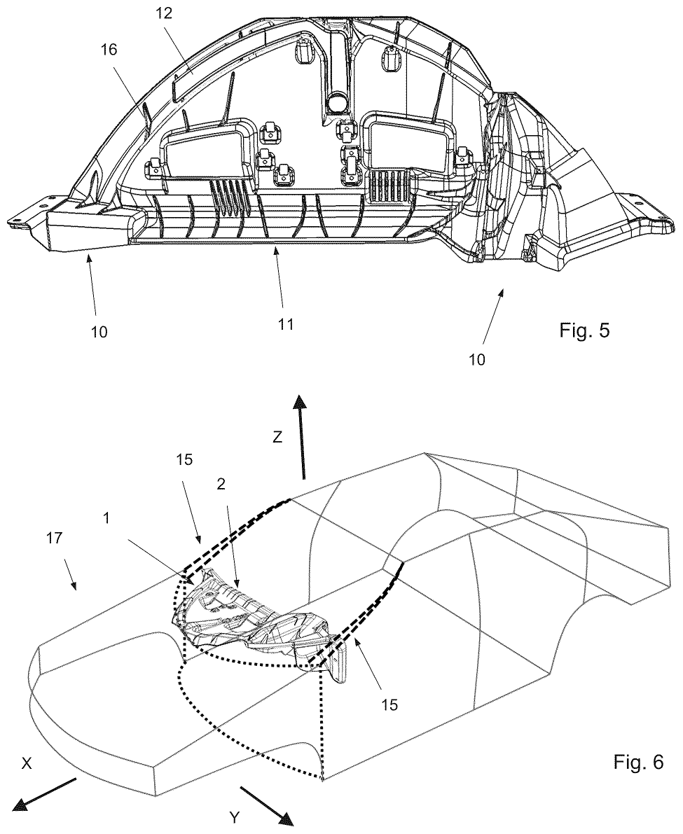

FIG. 1 shows a three-dimensional view of the upper side of an instrument panel crossmember 1 according to the present disclosure for a motor vehicle. The instrument panel crossmember 1 comprises a crossbeam 2, more easily visible in FIG. 2. The crossbeam 2 extends in the Y direction transversely to the vehicle longitudinal direction X from one A pillar 15 to the opposite A pillar 15 of a motor vehicle, this being readily apparent from FIG. 6. In the direction of the vehicle front 17, the crossbeam 2 is adjoined by a plate 4, wherein at least one instrument opening 6 for the reception of an instrument is formed in the plate. The plate 4 preferably adjoins the crossbeam 2 integrally, with the result that the instrument panel crossmember 1 is formed in one piece or as a single whole. It is advantageous if the plate 2 is designed as a circular segment. The crossbeam 2 preferably has end portions 5 at the two opposite ends, wherein these can be configured differently, as is the case in the embodiment illustrated. In addition, the instrument panel crossmember 1 preferably comprises a support 3, which integrally adjoins the end portions 5 of the crossbeam 2. The support 3 extends in an arc shape in the direction of the vehicle front 17 or in the X direction and surrounds the plate 4 of circular-segment-shaped design. The vertex 8 of the arc-shaped support 3 forms the outermost point in the X direction of the support 3, and the ends of the support 3 integrally adjoin the crossbeam 2 or end portions 5. The crossbeam 2 and the support 3 surround the plate 4 arranged between them, at least in some region or regions. The partially framed plate 4, the support and the crossbeam 2 are preferably formed integrally or jointly as one part. The instrument panel crossmember 1 is produced from a material, preferably a metallic material. It is preferred that it be produced from a light alloy, and that the instrument panel crossmember 1 be produced as a single casting. At least in some portion or portions, preferably in the central portion 11, the crossbeam 2 preferably has a U-shaped cross section, which is open downwards or in the negative Z direction. This is readily apparent from FIGS. 3-5, in which the underside of the instrument panel crossmember 1 is shown. The portion designed as a U profile in the crossbeam 2 can preferably be used as a cable duct and/or to form a ventilation duct. Ribs 16 for additional reinforcements are preferably also arranged in the U-shaped cross section of the crossbeam 2. The support 3 preferably likewise has a U-shaped, downwardly open cross section into which cables can be laid, and/or the U shape can be used as part of a ventilation duct. FIG. 5 shows the use of the U shape of the support 3 as a ventilation duct, with a moulded plastic duct 12 being inserted into the downwardly open U shape. A duct cover can merely be laid on the U shape to form a duct. An HVAC unit is preferably arranged on the underside of the instrument panel crossmember 1, and this unit is then connected to the ventilation duct. There is then the possibility of making slots in the outside of the U-shaped support 3, these allowing air to be supplied to the windscreen. It is advantageous if at least one instrument opening 6 is provided in the plate 4, preferably for the arrangement of instruments such as imaging units of heads-up displays or other display devices. It has proven to be an advantageous embodiment if at least two instrument openings 6 are provided in the plate 4. This is because there is an observed trend that, in addition to important information for the driver, future vehicles will also project the surroundings, incorporated in the form of augmented reality, onto the windscreen, it being possible, by the arrangement of a plurality of imaging units, for these to be projected onto the full windscreen, although it is also not necessary for there to be direct projection onto the windscreen, projection onto separate projection surfaces also being possible. Of course, the instruments openings 6 can also be used for other instruments, such as a navigation system, or to display other driver information. In FIGS. 1 and 2, the cooling surfaces 19, against which the imaging unit rests in surface contact, are readily apparent. To ensure even more efficient heat dissipation, the cooling surface 19 has cooling fins 20 on the side facing away from the imaging unit. These are readily apparent in FIGS. 3-5, in which the underside of the instrument panel crossmember 1 is visible. Via the cooling fins 20, the heat generated by the imaging units can be dissipated passively and efficiently to the ambient air.

The instruments are preferably fixed by means of clamping elements, wherein the clamping elements are preferably fastened in the fastening openings 18 provided for them in the plate 4.

It has also proven advantageous if a duct 7 extends between the vertex 8 of the arc-shaped support 3 and the crossbeam 2. The duct 7 extends along the X direction and preferably adjoins the U shape of the support 3. This allows a continuous duct that makes a transition from the U shape of the support into the duct 7, and, as in FIG. 6, allows a possible ventilation duct as far as the HVAC unit, which is preferably arranged on the underside of the instrument panel crossmember 1. The duct 7 extends in the plate 4 or as an elongate recess on the underside of the instrument panel crossmember 1 and on the upper side through a protruding raised portion. In this case, the duct 7 can extend partially through the plate 4, as depicted, or, alternatively, through the entire plate 4. Moreover, the duct 7 also increases the stiffness of the instrument panel crossmember 1. It is furthermore advantageous if a steering column duct 9 extends in the X direction from the crossbeam 2 as far as the support 3. The steering column duct 9 is of U-shaped design and is open downwards or in the Z direction and, as a result, the steering column can pass through. Moreover, the steering column duct 9, in turn, forms a reinforcement in the instrument panel crossmember 1. Here too, ribs 16 can preferably be arranged in the U-shaped cross section. It is readily apparent from FIGS. 1-5 that the instrument panel crossmember 1 is a component of thin-walled design, that is to say that the wall thickness is in a range of from 1 to 4 mm. The two end portions 5 on the crossbeam 2 preferably have a tubular portion 10, as can be seen in the figures, wherein the cross section has a closed form in this portion. The tubular portion 10 adjoins the central portion of the crossbeam 2, which has a U-shaped cross section, this being readily apparent in FIG. 3. The portions do not have to adjoin one another directly; the steering column duct 9 can also pass between them, as on the other side. The tubular portions 10 on the end portion are preferably of conical design to allow demoulding. In the embodiment depicted, the tubular portion 10 of the crossbeam 2 has a boundary element 13, and as a result a continuous duct from the A pillar to the opposite A pillar 15 is no longer formed. Of course, it is also possible to omit the boundary element 13, and a continuous duct is formed between the A pillars 15. A-pillar connections 14 are arranged on the outer ends of the end portions 5 of the crossbeam 2, by means of which the instrument panel crossmember 1 is fastened to the A pillars 15. The instrument panel crossmember 1 can thereby be joined to the A pillars 15 of the body.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Instrument panel crossmember
2 Crossbeam
3 Support
4 Plate
5 End portion
6 Instrument opening
7 Duct
8 Vertex
9 Steering column duct
10 Tubular portion of the end portion
11 Central portion of crossbeam
12 Plastic duct
13 Boundary element
14 A-pillar connection
15 A pillar
16 Rib
17 Vehicle front
18 Fastening openings
19 Cooling surface
20 Cooling fins
X Vehicle longitudinal direction
Y Transverse to the vehicle longitudinal direction or at right angles horizontally to the vehicle longitudinal direction
Z Perpendicular to the vehicle longitudinal direction

1. An instrument panel crossmember of a motor vehicle, comprising a crossbeam,
wherein the crossbeam extends transversely to a longitudinal direction of the motor vehicle from an A pillar to an opposite A pillar,
wherein the crossbeam is adjoined in a direction of the vehicle front by a plate, and
wherein at least one instrument opening configured for reception of an instrument is formed in the plate.

2. The instrument panel crossmember according to claim 1, wherein the plate is arranged integrally on the crossbeam.

3. The instrument panel crossmember according to claim 1, wherein the instrument panel crossmember is produced from a metallic material.

4. The instrument panel crossmember according to claim 1, wherein the plate runs horizontally.

5. The instrument panel crossmember according to claim 1, wherein the instrument panel crossmember is configured as a thin-walled, one-piece component.

6. The instrument panel crossmember according to claim 1, wherein the at least one instrument opening is arranged in the plate for reception of an imaging unit.

7. The instrument panel crossmember according to claim 1, wherein at least two instrument openings are arranged in the plate for reception of imaging units.

8. The instrument panel crossmember according to claim 6, wherein the at least one instrument opening has a cooling surface, against which the imaging unit rests in surface contact and which carries away heat from the imaging unit.

9. The instrument panel crossmember according to claim 6, wherein the at least one instrument opening has a cooling surface, on which cooling fins are arranged on a side facing away from the imaging unit.

10. The instrument panel crossmember according to claim 1, wherein fastening openings configured to fasten the instruments are arranged in the plate.

11. The instrument panel crossmember according to claim 1, wherein the plate is surrounded by a support in the direction of the vehicle front, at least in some region or regions.

12. The instrument panel crossmember according to claim 1, wherein the crossbeam has a U-shaped cross section, at least in some portion or portions.

13. The instrument panel crossmember according to claim 11, wherein the support has a U-shaped cross section.

14. The instrument panel crossmember according to claim 1, wherein the instrument panel crossmember is configured as a light-alloy diecasting.

15. A method for producing the instrument panel crossmember according to claim 1, comprising producing the instrument panel crossmember by diecasting.
